(19) United States
(12) Patent Application Publication
(10) Pub. No.: US 2025/0208653 A1
(43) Pub. Date: Jun. 26, 2025

(54) ELECTRONIC DEVICE CASE

(71) Applicant: SOLAR-TEL, LLC, Mishawaka, IN (US)

(72) Inventor: GARY VANWAEYENBERGHE, Mishawaka, IN (US)

(73) Assignee: SOLAR-TEL, LLC, Mishawaka, IN (US)

(21) Appl. No.: 18/983,769

(22) Filed: Dec. 17, 2024

Related U.S. Application Data
(60) Provisional application No. 63/612,775, filed on Dec. 20, 2023.

(51) Int. Cl. G06F 1/16; H02J 7/00; H02J 7/35; H02J 50/10; H02J 50/90; H02S 20/30; H02S 40/32

(52) U.S. Cl. CPC G06F 1/1629; H02J 7/0044; H02J 7/35; H02J 50/10; H02J 50/90; H02S 20/30; H02S 40/32; H02J 2207/20

(57) ABSTRACT

An electronic device case particularly useful for tablets and cell phones. The device case has a sidewall with an overhanging wall that properly positions the electronic device adjacent to a back wall for efficient wireless charging. A solar cell is affixed to the back wall and faces outwardly of the case. An inverter is directly connected to the solar cell and is for converging direct current from the solar cell into alternating current upon light being received onto the solar cell. An inductive coil is directly connected to the inverter so that the inductive coil provides an alternating magnetic field upon light being received onto the solar cell. No battery is required within the device case and it relies solely on power from the solar cell.

### BACKGROUND OF THE INVENTION

Portable electronic devices have become smaller and more useful over time. There are many technological reasons for the increase in usefulness and decrease in size. The increase in usefulness and smaller size has made portable electronic devices more indispensable in many people's lives. One of the most indispensable electronic devices are cell phones, more particularly, smart phones. Cell phones may often be used in areas where there is a good signal to the phone, yet limited availability of electrical outlets for recharging or powering the phone.

Presently, there are large battery packs that exceed the size of the phone by three or four times. These bulky external battery packs are clumsy, but do serve their purpose of providing power where electrical outlets may not be readily available. These large battery packs are often connected to a phone by an electrical cord.

In some instances, cell phones can be charged without a cord. Wireless cell phone chargers have been used to charge phones without direct electrical connections. This is done through an induction of a coil within a charging device that is paired with a coil in the electronic device to be charged. In this wireless charging arrangement, electrical contacts do not need to be connected to charge a cell phone that is in close proximity to a charging device. Wireless charging devices are usually contained within a bulky battery pack or they can also be a version that is plugged into an electrical outlet. A significant problem with the battery pack style chargers is that they provide no means to locate the inductive coil within the charger in a consistent location with respect to the receiving coil in the phone. This same problem of poor location of the respective coils in the charger and phone is a problem with plug in wall chargers as well. In the case of a plug-in wireless charger, there is a significant margin of error for alignment of the coils because the wall outlet provides a significant amount of power that will allow the wireless charger to function even though it may not be well aligned to provide the best and most efficient charge.

There remains an unmet need to have a wireless charging device that requires no additional inconvenience or steps to use beyond ordinary use of the phone. There also remains a need to have a much lighter and more convenient charging method for wireless phones that can be used where electrical outlets may not be readily available.

### SUMMARY OF THE INVENTION

The invention is an electronic device case that has a sidewall and a back wall. The sidewall is for contacting the sides of the electronic device that is placed within the case. The sidewall has an overhanging wall that is opposite to the back wall. The overhanging wall is for engaging the electronic device adjacent to its screen. A solar cell is affixed to the back wall and faces outwardly from the case. An inverter is directly connected to the solar cell and is for converting direct current from the solar cell into alternating current upon light being received onto the solar cell. An inductive coil is directly connected to the inverter so that the inductive coil provides an alternating magnetic field upon light being received onto the solar cell.

### BRIEF DESCRIPTION OF THE DRAWINGS

FIG. 1 is a perspective view of the electronic device case with the electronic device contained therein;

FIG. 2 is a perspective view of the electronic device case shown in FIG. 1 showing the back side having solar cells thereon;

FIG. 3 is an exploded perspective view of the electronic device case shown in FIGS. 1 and 2;

FIG. 4 is a view of the electronic device case shown in FIG. 1-3, with the electronic device not being held within the case;

FIG. 5 is an exploded perspective view of the device case shown in FIGS. 1-4;

FIG. 6 is an exploded perspective view of the device case shown in FIGS. 1-5;

FIG. 7 is a sectional view taken about the line 7-7 in FIG. 1;

FIG. 8 is a sectional view taken about the line 8-8 in FIG. 4;

FIG. 9 is a is a schematic drawing of the electrical functions of the electronic device as it is coupled with the device case of the present invention.

### DETAILED DESCRIPTION OF INVENTION

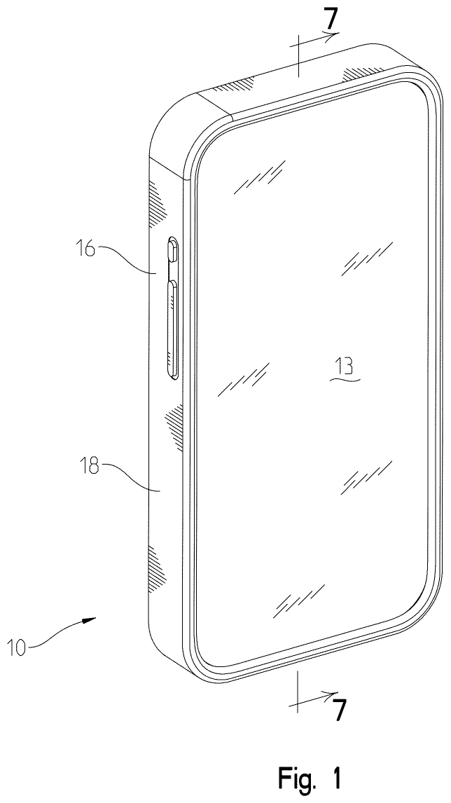

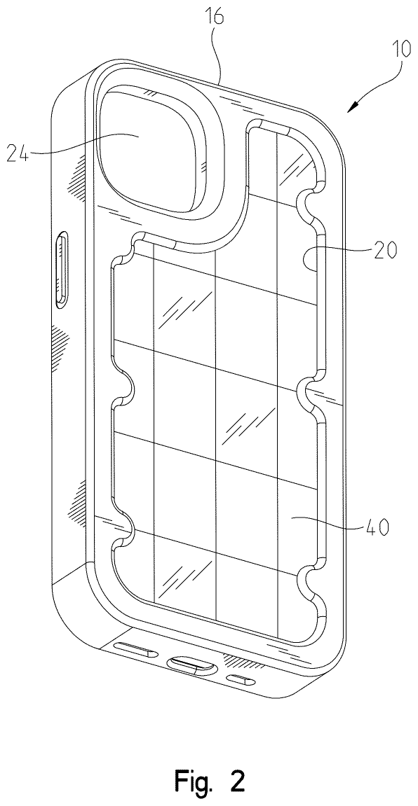

FIG. 1 shows a perspective view of the electronic device case 10 of the present invention. The case 10 has a frame 16 that includes a sidewall 18 that is connected to a back ledge 20 that extends inwardly of the sidewall 18. The frame 16 may be a molded plastic or high durometer rubber that will protect a phone or other electronic device placed in it. The case 10 is particularly useful for cell phones and may also be used for tablets. The back ledge 20 may include a cutout 24 for accommodating lenses of a camera of a typical cell phone. The back ledge 20 has an inner surface 25 and an outer surface 26. The inner surface 25 faces an interior 27 of the device case 10.

The sidewall 18 has an overhanging wall 28 that is spaced from and substantially parallel to the back ledge 20 and is adapted for securely wrapping around the electronic device 11 contained within the device case 10 and prevents the case 10 from falling off the cell phone or other device contained therein. The overhanging wall 28 acts as a bezel surrounding the screen 13 of an electronic device 11 contained within the device case 10 and has an upper surface 30 that is spaced from an oppositely located gripping surface 32 that is designed to rest against the electronic device 11 held in the device case 10. The upper surface 30 provides a spaced protective buffer around a screen 13 for the electronic device 11 in the device case 10. It is contemplated that the sidewall 18 and overhanging wall 28 are made of a resilient durable material that maybe flexed to tightly grip an electronic device 11 contained within the case 10.

An array of solar cells 40 is located on a solar cell module 41. The solar cell module 41 forms part of a back wall 58 of the case 10 in conjunction with other parts described below. The array of solar cells 40 provides direct electrical current when light shines upon the array of solar cells 40. The solar cells 40 have wires (not shown) that are connected to an inverter 44. The inverter 44 converts the direct electrical current (“DC”) from the solar cells 40 to alternating electrical current (“AC”). The array of solar cells 40 are placed in a manner to take up most of the area on the outside of the case 10 on the back side. The array of solar cells 40 are directly connected to the inverter 44. The inverter 44 only supplies AC power when light strikes the array of solar cells 40 because the inverter 44 converts the DC power from the array of solar cells 40 into AC. In other words, there is no battery or other intermediate device between the solar cells 40 and the inverter 44. As such, the inverter 44 is immediately responsive to the input from the array of solar cells 40 and can immediately produce AC power upon light striking the solar cells 40. The inverter 44 is directly connected to an inductive coil 50. As such, the inverter 44 immediately produces a fluctuating magnetic field upon light striking the array of solar cells 40. The only power the inductive coil 50 receives is from the solar cells 40 because no battery or other power source is needed or used to power the inductive coil 50. In prior art systems, solar cells are used to charge a battery that then is used to charge a separate battery within an electronic device. The present invention eliminates the inefficiency of having an intermediate battery and directs the solar energy into the electronic device 11 within the device case 10. A significant increase in efficiency is realized because each time energy is stored in a battery, some loss occurs. In prior art arrangements that charge a battery, there are two batteries; one of them being in a large solar cell battery box and the second one being in the electronic device that is connected to the large solar cell battery box. The present invention eliminates that inefficiency of charging two batteries by only charging one battery. The case 10 in the configuration of the present invention charges the battery within the device without a direct electrical connection such as a plug.

The inductive coil 50 is embedded into a coil module 51 that includes both the inductive coil 50 and the inverter 44. The inductive coil module 51 is held between the solar cell module 41 and a back plate 53. The array of solar cells 40 and the back plate 53 each have a plurality of holes 55, 56 respectively. The holes 55,56 are for receiving pegs 60 that extend from the inner surface 25 of the back ledge 20. The array of solar cells 40 is pressed against the inner surface 25 of the back ledge 20. The coil module 51 is placed against the array of solar cells 40, then the back plate 53 is seated against the array of solar cells 40 with the coil module 51 being located between the array of solar cells 40 and the back plate 53. The back plate 53 includes a recess 54 that is offset from a mounting surface 57 that directly contacts the array of solar cells 40. The coil module 51 is contained within the recess 54. The recess 54 may be customized to place the coil module 51 in an ideal location to optimize its interaction with a device placed within the case 10. The pegs 60 are then heat staked down so that the case 10 is completed. This staking joins the solar cell module 41 and the back plate 53 to form a back wall of the case 10 with the inductive coil 50 secured within the back wall. This locates the inductive coil 50 very near the device 11 that will be contained in the pocket 66 that is surrounded by the sidewall 18. It is contemplated that the inductive coil 50 may be molded directly into a back wall as a unitary part of the case 10.

The case 10 is installed onto an electrical device 11 which locates the inductive coil 50 in close proximity to the electrical device 11 contained within the device case 10. The device case 10 is similar in size and shape to traditional protective cases that provide no power charging capabilities. The form factor of the device case 10 is essentially the same as a traditional device case because it contains no battery, which conserves valuable space in the device case 10 of the present invention.

The device case 10 is used for charging and maintaining a charge when the electronic device 11 within the device case 10 has a receiving inductive coil 74 for wireless charging. The inverter 44 is set up to produce a standard wireless charging signal and may be such common standards as Qi or Power Matters Alliance (PMA). Depending on the available light that strikes the solar cells 40, the device case 10 can supply enough power to maintain the power consumption of the device 11 while it is in use or charge the device 11 within the device case 10 when the device 11 within it is not in use. Use of the device case 10 requires no extra parts separate from the electronic device 11 itself. This is particularly helpful for cell phone users because they no longer have to plan for extra accessories beyond what an ordinary user would do most of time, which is to use a protective cover on a cell phone. The device case 10 serves a protective case as well as a power source simultaneously.

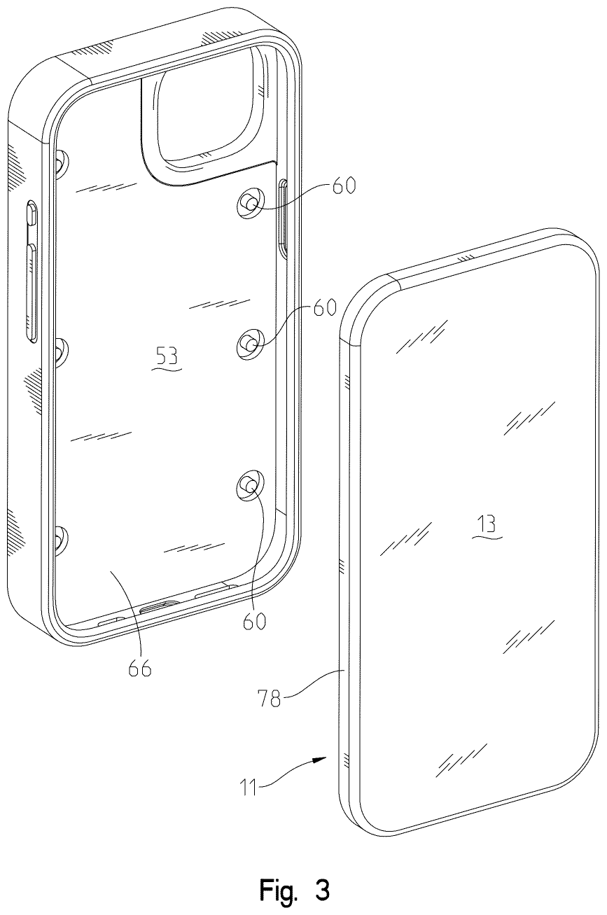

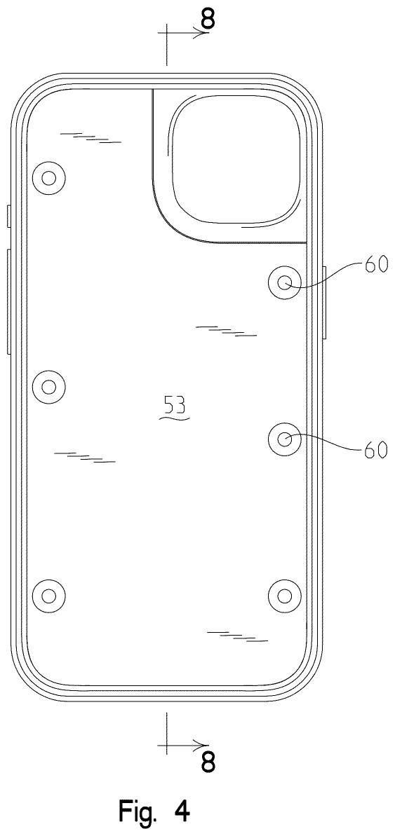

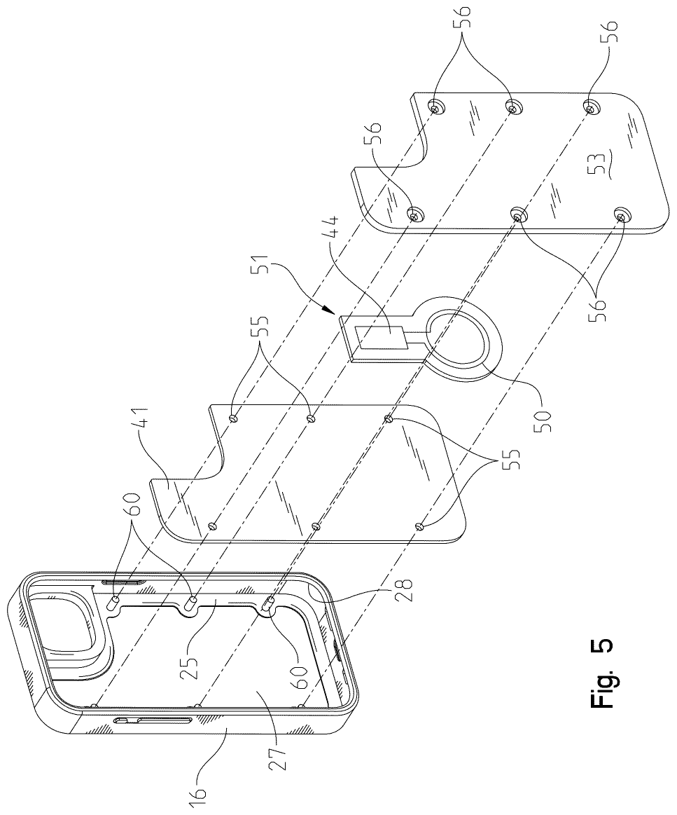

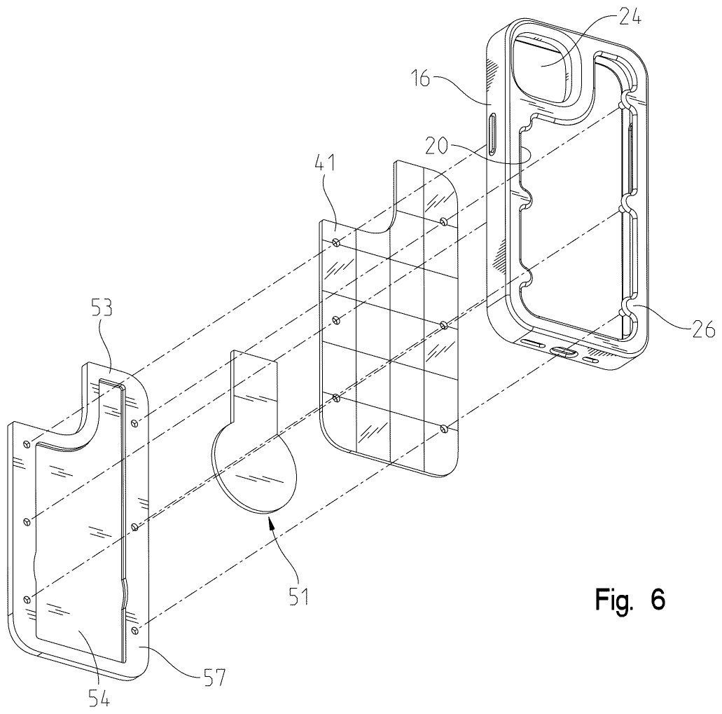

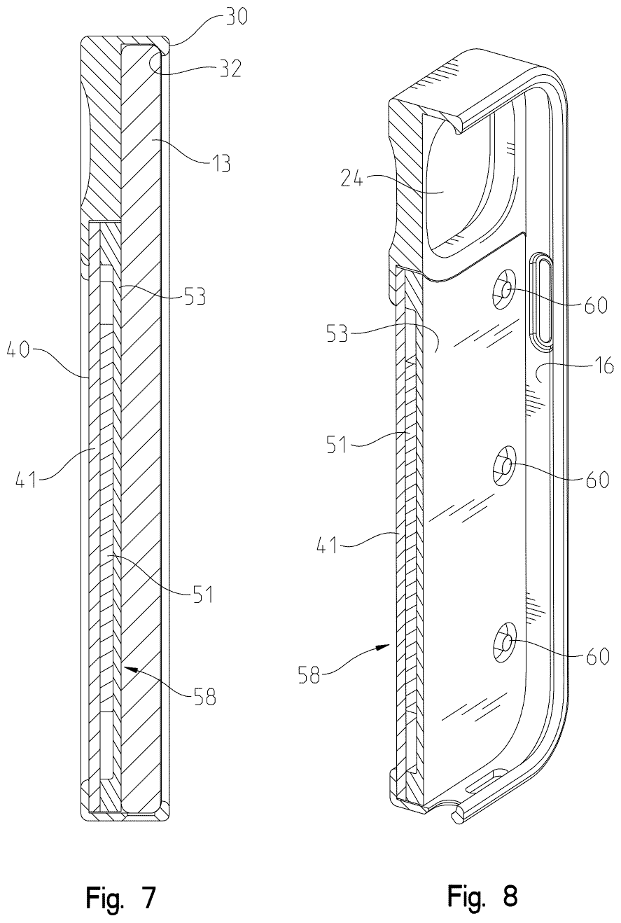

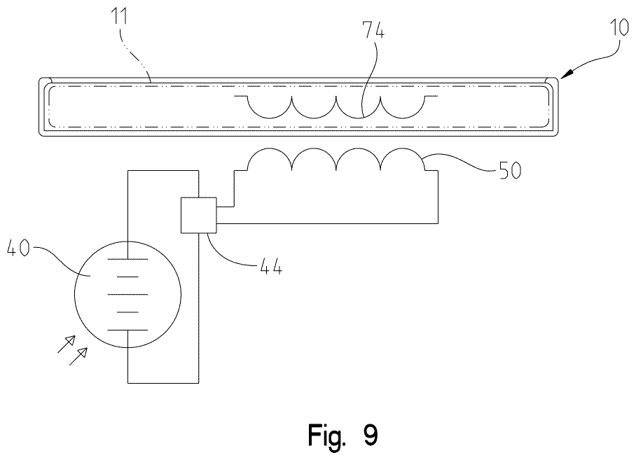

As can be seen in FIG. 3, the electronic device 11 placed into the case 10 as shown in the FIGS. happens to be a cell phone, but could be a tablet as well. The electronic device 11 has within it a receiving coil 74 that wirelessly receives the charging signal described above. The AC in the coil 50 produces an alternating magnetic field that induces electrical current to flow in the receiving coil 74. The electronic device 11 needs to have its receiving coil 74 near the inductive coil 50 of the case 10 for this to occur at an optimum level. If the inductive coil 50 is too far from the receiving coil 74 or misaligned, the power transfer will be weak. Larger distances between coils 50, 74 require more power to be supplied in the inductive coil 50 to charge the electronic device 11 through its receiving coil 74. Therefore, affirmatively fixing the electronic device 11 with respect to the inductive coil 50 is essential for proper function. The sidewall 18 of the case 16 engages the sides 78 of the electronic device 11 so that the receiving coil 74 of the electronic device 11 is aligned with the inductive coil 50. The overhanging walls 28 engage the electronic device 11 adjacent to its screen 13 to maintain the coils 50, 74 in close proximity. Other charging systems fail to affirmative locate the coils 50, 74 in the optimum position. This optimum location provides for the best power transfer and allows for rapid charging through use of the array of solar cells 40 alone. Prior art designs require a battery because the solar cells in those charging devices need enough time to build up power in a separate battery so that there is be enough power to power an inductive coil 50 that is usually not in an ideal position with respect to a receiving coil 74 of an electronic device 11. The case 10 of the present invention provides affirmative location that optimizes charging and therefore, requires less power. The precise and consistent location of the coils 50, 74 with respect to each other allows for the elimination of a separate battery outside of the case 10.

The present invention is not limited to the details given above but may be modified within the scope of the following claims.

What is claimed is:

1. An electronic device case comprising:
a frame having a sidewall and a back ledge extending inwardly from said sidewall, said frame including an overhanging wall extending inwardly from said sidewall, said overhanging wall being spaced from said overhanging wall;
a solar cell being affixed to said back ledge and said solar cell facing outwardly of said case;
an inverter being directly connected to said solar cell and converting direct current from said solar cell into alternating current upon light being received onto said solar cell; and
an inductive coil connected directly to said inverter so that said inductive coil provides an alternating magnetic field upon light being received onto said solar cell and said inductive coil only receiving its power from said solar cell.

2. The electronic device case of claim 1, wherein said inductive coil is located within a backwall between said solar cell and an electronic device placed in said case.

3. The electronic device case of claim 1, wherein said solar is contained on a solar cell module, said solar cell module having a plurality of holes, a back plate having a plurality of holes, said back ledge having a plurality of pegs, said holes in said solar cell module and said holes in said back plate being aligned with said pegs, and said pegs securing said solar cell module and said back plate to hold said inductive coil between said solar cell module and said backplate.

4. An electronic device case for use in combination with an electronic device having a receiving coil said case comprising:
a sidewall and a back wall, said sidewall contacting sides of said electronic device, said sidewall including an overhanging wall opposite said back wall, said overhanging wall engaging said electronic device adjacent to a screen of said electronic device;
a solar cell being affixed to said back wall and said solar cell facing outwardly of said case;
an inverter being directly connected to said solar cell and converting direct current from said solar cell into alternating current upon light being received onto said solar cell; and
an inductive coil directly connected to said inverter so that said inductive coil provides an alternating magnetic field upon light being received onto said solar cell and said inductive coil only receiving its power from said solar cell.

5. The electronic device protector of claim 4, wherein said solar is contained on a solar cell module, said solar cell module having a plurality of holes, a back plate having a plurality of holes, said backwall being formed from said solar cell module, said back plate and said back wall, said sidewall having a back ledge having a plurality of pegs, said holes in said solar cell module and said holes in said back plate being aligned with said pegs, and said pegs securing said solar cell module and said back plate to hold said inductive coil between said solar cell module and said backplate.

6. An electronic device case comprising:
a sidewall and a back wall, said sidewall for contacting sides of said electronic device contained within said case, said sidewall including an overhanging wall opposite said back wall, said overhanging wall for engaging said electronic device adjacent to a screen of said electronic device;
a solar cell being affixed to said back wall and said solar cell facing outwardly of said case;
an inverter being directly connected to said solar cell and converting direct current from said solar cell into alternating current upon light being received onto said solar cell;
an inductive coil directly connected to said inverter so that said inductive coil provides an alternating magnetic field upon light being received onto said solar cell and said inductive coil only receiving its power from said solar cell; and
an inductive coil connected directly to said inverter so that said inductive coil provides an alternating magnetic field upon light being received onto said solar cell and said solar cell directly powering said inductive coil through said inverter.

7. The electronic device case of claim 6, wherein said solar cell is contained on a solar cell module, said solar cell module having a plurality of holes, a back plate having a plurality of holes, said sidewall having a back ledge having a plurality of pegs, said holes in said solar cell module and said holes in said back plate being aligned with said pegs, and said pegs securing said solar cell module and said back plate to hold said inductive coil between said solar cell module and said backplate.

8. The electronic device case of claim 6, wherein said case includes no battery.
